(19) United States
(12) Patent Application Publication
(10) Pub. No.: US 2014/0351104 A1
(43) Pub. Date: Nov. 27, 2014

(54) Data Managment Systems And Processing For Financial Risk Analysis

(71) Applicants: Emmanuel Abbe, Lausanne (CH); Amir Khandani, New York, NY (US); Andrew W. Lo, Weston, MA (US)

(72) Inventors: Emmanuel Abbe, Lausanne (CH); Amir Khandani, New York, NY (US); Andrew W. Lo, Weston, MA (US)

(73) Assignee: Andrew Lo, Weston, MA (US)

(21) Appl. No.: 14/453,446

(22) Filed: Aug. 6, 2014

Related U.S. Application Data
(63) Continuation of application No. 13/252,944, filed on Oct. 4, 2011.

(51) Int. Cl. G06Q 40/00

(52) U.S. Cl. CPC G06Q 40/12
USPC 705/30

(57) ABSTRACT

A computer based system and method is directed to the determination of aggregate metrics of select financial indicators utilizing a protocol that preserves the confidentiality of the individual data sets comprising the aggregate metrics. The data processing system provides industry wide transparency of financial risk, concentration and the like based on data associated with individual firms free from risk of subsequent reverse determination of the underlying data.

### CROSS-REFERENCE TO RELATED APPLICATIONS AND PRIORITY CLAIM

This application is a continuation of and claims priority to U.S. utility patent application Ser. No. 13/252,944, filed Oct. 4, 2011, sharing the same title, which application is incorporated by reference herein in its entirety.

### FIELD OF THE INVENTION

The present invention relates to data system and methods for measuring financial metrics without revealing core participant attributes. More particularly, the present invention provides a data management system and process that utilizes individual financial firm's confidential data to develop financial attributes in a manner that preserves the confidentiality of the individual firm data.

### BACKGROUND OF THE INVENTION

During the financial crisis of 2008, a significant systemic risk associated with certain financial instruments (subprime mortgage secured debt and credit default swaps for example) contributed to a financial meltdown that was largely unforeseen by regulators and the major market participants. Part of the problem was that substantial financial firms with significantly risky portfolios were under no obligation to report these exposures—and indeed, had a great incentive to keep such data secret. For competitive purposes, financial metrics for most banks and brokerages are kept as critical trade secrets and the information and its confidentiality is highly prized and protected. Because of this, efforts to make industry risk exposures more transparent are particularly difficult or even impossible absent some mechanism to protect the individual bank confidential data from public (and competitor) access.

Government regulators have responded to the unsettled markets of the past several years by instituting regulatory oversight of the financial firms. This oversight involves intrusive demands for proprietary trading practices and security holdings that have been long antithetical to the banking culture found in the capital markets. For example, bank regulators have been actively pursuing access to key confidential financial data from individual banks so that their economists can perform “stress tests” on the bank holdings. These tests measure the bank's individual ability to weather a series of adverse market events such as a drop in real estate prices increasing mortgage default rates and/or changes in one or more key interest rates.

The fundamental predicate for this intrusive oversight is one that depends on the concept of the trusted third party—here the regulatory agency. Many do not believe that this approach alone will be sufficient. The inventors of the present invention have recognized the above problem and developed a novel solution that is described below.

### OBJECTS AND SUMMARY OF THE PRESENT INVENTION

It is an object of the present invention to provide a secure mechanism for processing highly confidential data to create aggregate metrics of risk and performance that cannot be used subsequently to generate the confidential data underlying the metrics.

It is another object of the present invention to provide the data processing system that supports the calculation of aggregate statistical data relating to the contributions of individual data sources where the individual data is not revealed and cannot be reverse engineered.

It is yet another object of the present invention to provide a computer platform of interconnected servers configured to implement a program controlled protocol for aggregating confidential financial information and to develop plural statistical measures such as the arithmetic mean of industry risk exposures based on data from individual financial firms without revealing the underlying data.

It is still a further object of the present invention to provide a process of managing and interpreting financial data that results in aggregate measures using a set of calculations that are applied to highly confidential individual firm data but are implemented to prevent the resulting measures from being reverted back to the starting data for the individual firms.

The above and other objects of the present invention are realized in an illustrative data processing system that implements selected algorithms on individualized data, communicates certain modified information to secondary processes that are programmed to aggregate the received values. For the financial firm application, the system determines, inter alia, financial industry metrics such as total equity, average leverage ratio, aggregate value at risk, Herfindahl index or other concentration ratios for select securities, and median or other quantiles of pair-wise correlation. These calculations, however, employ selectively configured algorithms such as (i) computing the inner product of two parties' real vectors, (ii) computing the sum of m parties' real numbers, and (iii) computing the quantiles of m parties' real numbers. Using this process, the system securely calculates one or more statistical measures applicable to the entire population of participating firms and their data—but without any meaningful threat of exposing the underlying data applied in the calculation.

The varying arrangements applicable for implementing the present invention include the use of both information-theoretic and cryptographically secure approaches with specific calculations employing full or mixed hardware and/or software system architectures for the governing calculations.

The foregoing and other features of the present invention are further presented in the detailed disclosure, taken in conjunction with the following diagrams depicting a specific illustrative embodiment of the present invention of which:

### BRIEF DESCRIPTION OF THE FIGURES

FIG. 1 is a block diagram of an illustrative data processing system supporting the implementation of the present invention in the financial industry;

FIG. 2 is a logic flow chart for implementation of the present invention;

FIG. 3a is a illustrative circuit diagram; and

FIG. 3b is a second illustrative circuit diagram.

### DESCRIPTION OF THE INVENTION AND ILLUSTRATIVE EMBODIMENTS THEREOF

The present invention solves the problem of transparency in an otherwise highly secretive financial industry. In one embodiment, the invention resides in a process where financial firm confidential information is used to develop aggregate metrics for assessing industry wide attributes relating to risk, concentration, liquidity and the like. The inventive process is implemented in a way to largely preclude subsequent efforts to use the resulting industry-wide data to ascertain the confidential individual firm information—thus providing individual confidentiality concurrent with industry transparency on select financial metrics.

The present invention also includes selectively programmed computer systems and programmed controlled processors for implementing the process steps needed to determine industry-wide metrics while concurrently protecting individual firm data confidentiality. This operative architecture is based on, in one example, a multiple server environment with system managing software at individual firm locations and/or in communication with individual firm data centers to permit access to the underlying confidential information. The selected hardware is based on the speed and capacity of the system as defined by the size and complexity of the data sets under management. Inter-firm communication is supported by a dedicated link or by one or more Internet protocols (TCP/IP) on a public access network. Operative software involves database management and access tools, such as SQL servers, utilizing SAP® or Oracle® platforms. In operation, the system computes for example the aggregate risk exposures of a group of financial institutions as expressed by the Herfindahl index of the credit default swaps market, the aggregate leverage of the hedge-fund industry, or the margin-to-equity ratio of all futures brokers without jeopardizing the privacy of any individual institution. In one embodiment, individual firm data is not removed from firm's premises in its native form.

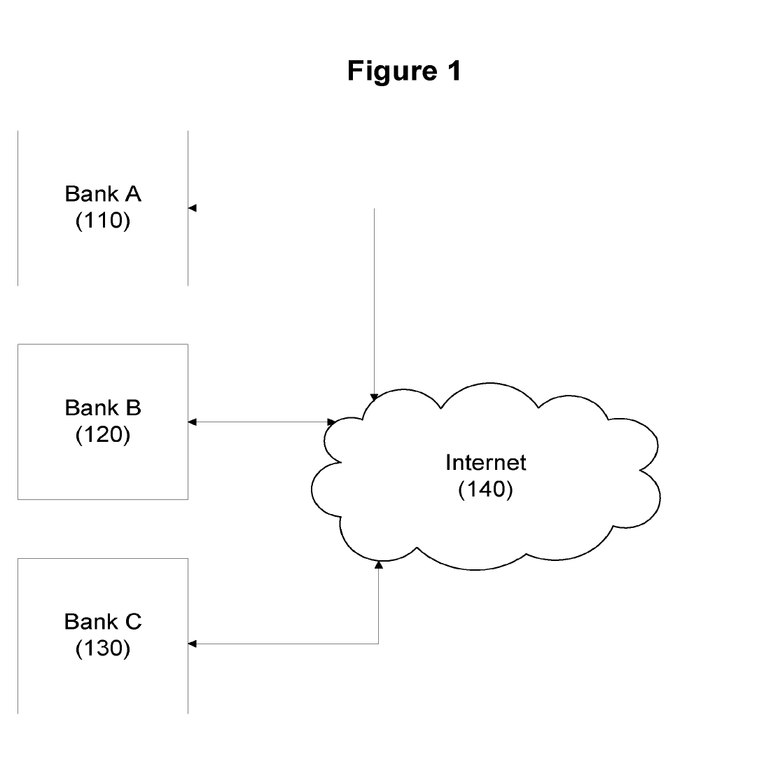

An exemplary hardware arrangement for purposes of the present invention is depicted in block diagram form in FIG. 1. To facilitate easier understanding of the invention, FIG. 1 assumes that only three financial firms are operatively connected to the managing system/software. It is understood by those skilled in the art that more than three banks or institutions may be interconnected and participate in the operations of the present invention. Beginning with Block 110, Bank A includes a server-based computer network and is linked for communications with the other two banks provided in this Figure. In addition, while Bank B and Bank C are identified as block 120 and 130 respectively, these additional participants may be commercial banks, investment banks, bank holding companies, hedge funds, mutual funds, insurance companies and other entities that may benefit from the system implementations described herein.

Each of the participating Banks (and, in particular, the computer platform depicted in FIG. 1) communicates with the others to share data, which will be discussed in more detail below. While the illustrative system of FIG. 1 supports communications via Internet Cloud 140, other data links may be employed consistent with the operative features of the present invention. This may include dedicated trunk line services, wireless, satellite or other digital transmission mediums that support the data rates implicated by the present invention.

The properly programmed system of FIG. 1 enables a group of financial institutions, such as commercial banks, investment banks, hedge funds, asset managers and financial auditing firms, to cooperate with each other by computing aggregate metrics on their joint data without jeopardizing their data privacy. In the financial industry, exemplary application of the present invention is presented in the context of three illustrative data sets. The first is targeted at the financial audit. Specifically, financial firms hold many financial assets that are relatively illiquid, and thus are difficult to price in a rapidly changing price environment. Current practice requires auditors to use projections regarding future market conditions regarding, inter alia, credit impairment issues. Application of the present invention to valuation data allows auditors and other bank regulators to compare asset valuation protocols on an industry wide basis.

The second application in the financial industry involves the monitoring of private investments placed with third party managers by large institutional investors such as pension funds or mutual fund families. In this application, the individual vendors wish to keep their investment choices secret, while the central pension fund wishes to avoid concentrating investments into risky pools unknowingly. In addition to concentration ratios and the like, use of the inventive protocols permits levels of risks and thus compliance with pension plan dictates.

The third application in the financial industry is directed to index based securities. These are typically a basket of disparate components that are priced at market for the individual components and then aggregated into a single tradable security. In addition, these indexes form the basis for complex derivatives contracts that are traded in the futures or options markets. Many of the underlying assets to these indexes and contracts are relatively illiquid and thus difficult to price. Most financial firms however have some methodology to determine current price for these assets. In this context, the present invention operates to develop aggregate pricing for one or more underlying asset based on proprietary pricing models used by the individual firms. While aggregate pricing becomes available to all, the confidential pricing estimates from the models themselves remain shielded from disclosure by the methodologies implemented by inventive data processing system.

While the above focus has been on financial/banking metrics, the approach herein may be applied to other measures including system-wide aggregate quantities such as equity, leverage, concentration index, NAV of money market funds, and system-wide aggregate risk exposures. Other applications including monitoring system liquidity risk at exchanges, prime brokers, private equity funds, and financial audit. As noted below, further uses include due diligence for new investments and new trading indexes.

To briefly illustrate just one example, the Herfindahl index, a simple measure of concentration, is given by the summation Σⁿᵢ₌₁s²ᵢ, where sᵢ is the fraction of market shares of firm i in the industry, considering the n largest firm. To compute securely this index, parties can first engage in an algorithm to determine the total market size using the secure sum algorithm provided below in the Example. Once the overall market size is known, market share, sᵢ, can be calculated and secure sum algorithm can be executed for a second time to determine the desired metric.

In one embodiment of the present invention, multi-party computations are securely accomplished using information-theoretic algorithms to protect confidential internal data underlying the calculations. In a second embodiment, the multi-party computations are securely accomplished using encryption techniques. These are discussed below with specific algorithms and examples.

The techniques discussed here cover the case where participants are honest but curious (i.e., participants follow the protocol, but try to extract as much information as they can from the message exchanges). In the honest but curious scenario, the participants cannot learn very much from the message exchange. An alternative scenario is where participants are dishonest—for example, providing false information to the other participants. Further extensions to the algorithms can be applied to add more robustness to the system to frustrate the efforts of dishonest participants to “game” the system. Other known techniques exist to address dishonest participants.

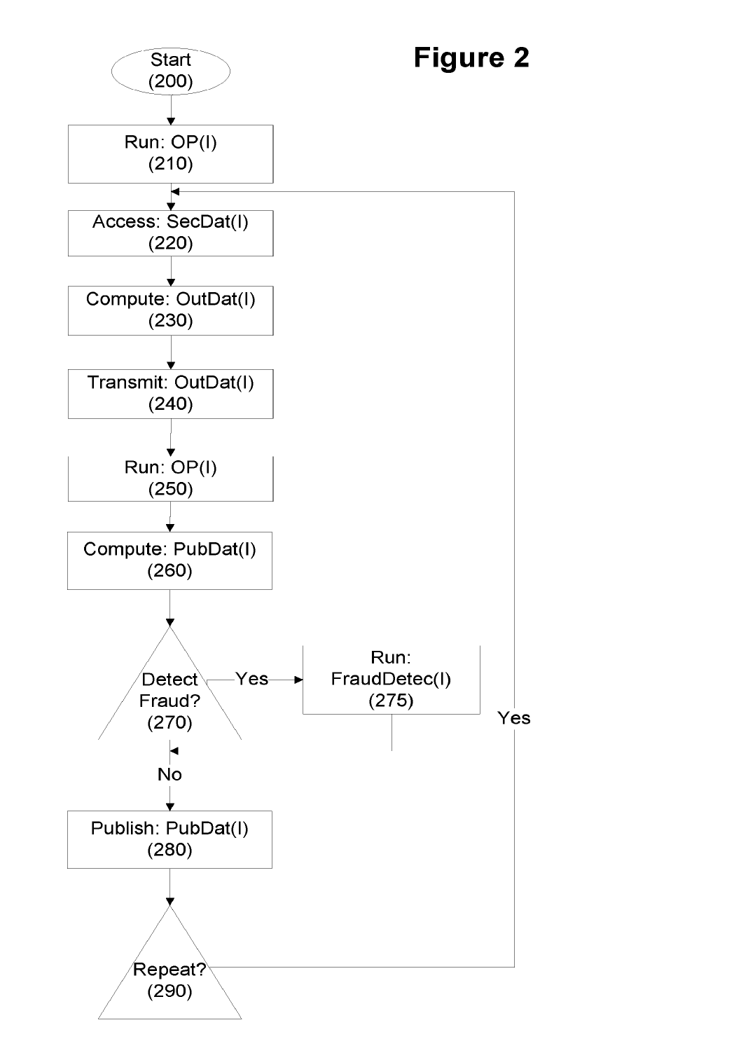

An exemplary process flow is depicted in FIG. 2. At block 200, the process starts and the program is run, 210, at or for an institution. The program accesses the institution's secret data, 220, and then computes random numbers for each other participating institution, 230. These random numbers are then transmitted to the respective other participating institution associated with the number, 240. The random numbers generated by the other participating institutions for the institution are received by the institution, 250. Steps 240 and 250 may occur in any order, including concurrently. Using the numbers received and the institution's secret data, the program then computes a public number, 260. Optionally, the system may include a fraud detection feature, 270, to determine whether one or more participants are being dishonest (i.e., not following the protocol), 275. At step 280, the public data is published or transmitted to the other participating institutions. The collective public information can be used to securely determine aggregate financial data, such as the arithmetic mean. In one embodiment, the system repeats the procedure in order to compute additional information, 280. For example, summation and averages may be determined with one iteration, correlation and covariance may be determined with two iterations, and quantiles may be determined with three or more iterations. Multiple iterations are used to increase system security and fidelity.

### Information Theoretic Approach

We present in this section two protocols to securely compute summations and inner products between quantized real numbers. Use of these protocols permits the secure computation of arithmetic mean, standard deviation, covariance, correlation, and several other functions and statistical measures. Each protocol is efficient and requires only one or two communication rounds and instantaneous function computations. The protocols are practical and can run real time, at the speed of the employed communication media (e.g., order of a second with a fast LAN). Different scenarios for the behavior of the parties can be considered. When the parties follow the protocols, information-theoretic security (without relying on cryptographic hardness assumptions) is ensured with the protocols described below. Several extensions can be obtained when the parties are malicious or active adversaries (using for example techniques as in Z. Beerliova and M. Hirt, Efficient Multi-party Computation with Dispute Control, Theory of Cryptography in Lecture Notes in Computer Science, 2006, Volume 3876/2006, 305-328, herein incorporated by reference).

### Information Theoretic Secure Sum Algorithm

All parties set a common range for their input magnitudes and a common quantization level within that range. Securely computing the summation of quantized values is then obtained by securely computing the summation of integers.

The protocol for the Information Theoretic Secure Sum Algorithm is described as follows:

Common inputs: qε [symbol] ₊ (the quantization level) and mε [symbol] ₊ (the number of parties).
For i=1, . . . , m:
Party i inputs: xᵢε [symbol] _{q}.
Common output: Σᵢ₌₁^{m}xᵢ.
   1. For i=1, . . . , m, party i provides to party j (for j=1, . . . , m and j≠i) a number Rᵢⱼ drawn uniformly at random in [symbol] _{mq}.
   2. For i=1, . . . , m, party i computes

$${s}_{i} = {\sum }_{j ∈ {\{ 1 , … , m \}}_{j \neq i}} {R}_{ji} + {x}_{i} - {\sum }_{j ∈ {\{ 1 , … , m \}}_{j \neq i}} {R}_{ij}$$

mod mq and publicly reveals sᵢ.
3. Each party computes Σᵢ₌₁^{m}sᵢ mod qm, which equals Σᵢ₌₁^{m}xᵢ.

Extensions: One may require fewer random numbers to be exchanged (this will result in less communication but also in less robustness in the case where parties may deviate from the protocol by cooperating with each to ascertain private data), or one can use polynomial or linear subspaces to share the numbers such that smaller subset of parties can recover the output. As explained previously, extensions to active adversaries can also be obtained. One may also add virtual parties that take part in the protocol (artificially) to augment the security and prevent parties from attempting to collaborate as a method to ascertain private information about other parties' inputs.

### Example of Information Theoretic Secure Sum Algorithm

The following illustrative example is used to facilitate understanding of the invention. There are three banks in the banking industry, Bank A, Bank B, and Bank C. Each of the banks possesses a number from 1-5 representing their risk exposure. The banks would like to keep their respective risk exposure number confidential and proprietary; however, they would also like to know the average risk exposure of the banking industry, without revealing anything about their own number other than what can be deduced by knowing the average.

Each column in the matrices below represents the data that the party has access to. The banks' respective risk exposure numbers are shown below:

| | Bank A | Bank B | Bank C |
|---|---|---|---|
| Risk Exposure | 4 | 2 | 3 |

An exemplary embodiment of the algorithm follows. Each party assigns a number between 1 and 20 to other parties. For example, Bank A assigns 10 to Bank B and 8 to Bank C. The table below shows the view for each bank.

| | Bank A | Bank B | Bank C |
|---|---|---|---|
| Risk Exposure | 4 | 2 | 3 |
| Bank A Assignment | | 10 | 8 |
| Bank B Assignment | 14 | | 12 |
| Bank C Assignment | 8 | 4 | |

Each party completes its row by calculating a number that, when added to the two numbers it assigned to the other parties it, results in a multiple of 20 plus its (secret) risk exposure number. For example, since Bank A assigned 10 and 8 (10+8=18) to the other parties, and its risk exposure is 4, it needs a total of 24 (20+4). Accordingly, the number needed to complete Bank A's row is 6 (24−18=6). The table below shows the view for each bank after this calculation has been done.

| | Bank A | Bank B | Bank C |
|---|---|---|---|
| Risk Exposure | 4 | 2 | 3 |
| Bank A Assignment | 6 | 10 | 8 |
| Bank B Assignment | 14 | 16 | 12 |
| Bank C Assignment | 8 | 4 | 11 |

Each party then calculates the sum of the numbers in its column (excluding the secret risk exposure number) module 20. For example, Bank A calculates 6+14+8=28 mod 20=8. This public number is shared with the other banks.

| | Bank A | Bank B | Bank C |
|---|---|---|---|
| Risk Exposure | 4 | 2 | 3 |
| Bank A Assignment | 6 | 10 | 8 |
| Bank B Assignment | 14 | 16 | 12 |
| Bank C Assignment | 8 | 4 | 11 |
| Column Total | 8 | 10 | 11 |

Finally, all parties calculate the sum of publically released numbers module 20. In this case: 8+10+11=29 mod 20=9. This 9 represents the sum of all three banks secret risk exposure numbers (4+2+3=9). From this final number, the average risk exposure of the banking industry can be calculated (9/3=3).

### Information Theoretic Secure Inner Product Algorithm

We present a secure protocol to compute correlations between two vectors of real quantized numbers.

Definition: We now define the precise expression for the sample correlation in terms of the inner product of the two data points after certain centering and normalization has been applied. The sample correlation of two time series

x={xᵢ}ᵢ₌₁^{t} and y={yᵢ}ᵢ₌₁^{t}

is given by:

$$ρ ( x , y ) = \frac{{\sum }_{i = 1}^{t} {x}_{i} {y}_{i} - t \overline{x} \overline{y}}{( t - 1 ) {s}_{x} {s}_{y}} = {\sum }_{i = 1}^{t} {\tilde{x}}_{i} {\tilde{y}}_{i}$$

$$where \overline{x} = \frac{1}{t} {\sum }_{i = 1}^{t} {x}_{i} , {s}_{x} = {( \frac{1}{t - 1} {\sum }_{i = 1}^{t} {( {x}_{i} - \overline{x} )}^{2} )}^{1 / 2} , \\ \overline{y} = \frac{1}{t} {\sum }_{i = 1}^{t} {y}_{i} , {s}_{y} = {( \frac{1}{t - 1} {\sum }_{i = 1}^{t} {( {y}_{i} - \overline{y} )}^{2} )}^{1 / 2} , \\ {\tilde{x}}_{i} = \frac{1}{{( t - 1 )}^{1 / 2}} ( {x}_{i} - \overline{x} ) / {s}_{x} and$$

$${\tilde{y}}_{i} = \frac{1}{{( t - 1 )}^{1 / 2}} ( {y}_{i} - \overline{y} ) / {s}_{y} are real valued .$$

The following protocol supports information-theoretic security and uses a third virtual party that does not possess inputs and does not receive meaningful information about other parties' inputs. It is there to help for the computation. The solution below does not require any cryptography, and relates to the basic idea of secret sharing (see, for example, Shamir, How to share a secret, Communications of the ACM 22 (1979), 612-613 (hereinafter “Shamir”) and herein incorporated by reference), as also used in the protocols of O. Goldreich, S. Micali, and A. Wigderson, How to play any mental game, Proceedings of the 19^{th} Annual ACM Symposium on Theory of Computation. (STOC), 1987, New York, N.Y. (hereinafter “GMW”) and herein incorporated by reference, and R. Cramer, I. Damgard, S. Dziembowski, M. Hirt, and T. Rabin, Efficient multiparty computations with dishonest minority, Proceedings of EuroCrypt, SpringerVerlag LNCS series, 1999 (hereinafter “CDDHR”) and herein incorporated by reference.

The algorithm is explained below:

Common inputs: q (the quantization level), t (the dimension of the time series), such that qt² is a power of a prime.
Party 1 inputs: x₁, . . . , xₜε [symbol] _{q}.
Party 2 inputs: y₁, . . . , yₜε [symbol] _{q}.
Party 3 inputs: none.
   1. for i=1, . . . , t,
      (a) party 1 splits xᵢ in three shares xᵢ(1)=aᵢ(1), xᵢ(2)=aᵢ(2) and xᵢ(3)=aᵢ(3), where aᵢ is a random affine¹ function on [symbol] _{q}_{²}ₜ with aᵢ(0)=xᵢ. Share aᵢ(j) is revealed to party j for j=2, 3,
      (b) party 2 splits yᵢ in tree shares yᵢ(1)=bᵢ(1), yᵢ(2)=bᵢ(2) and yᵢ(3)=bᵢ(3), where bᵢ is a random affine function on [symbol] _{q}_{²}ₜ with bᵢ(0)=yᵢ. Share bᵢ(j) is revealed to party j for j=1, 3.
   2. For j=1, 2, 3,
      (a) party j computes c(j)=Σᵢ₌₁^{t}aᵢ(j)bᵢ(j) mod qt²,
      (b) party j splits 0 in three shares zⱼ(k), k=1, 2, 3, where zⱼ is a random degree-2 polynomial on [symbol] _{q}_{²}ₜ with zⱼ(0)=0, and shares zⱼ(k) with party k,
      (c) party j reveals ρ(j)=c(j)+Σₖ₌₁³2ₖ(j) mod q²t to the other parties.
   3. Party 1 and 2 compute ρ(0) by interpolating a degree 2 polynomial on ρ(j), j=1, 2, 3, obtaining the correlation.

A random affine function is a function x [symbol] ax+b where a and b are drawn independently and uniformly at random in [symbol] . Note that one can extend the algorithm to arbitrary values of q and t, without requiring q̂2t to be a power of prime. For instance, if the original q and t do not match this condition, one can use zero-padding (adding zeros to the data stings) to reach the desired condition. As explained previously, extensions to active adversaries can also be obtained. One may also add virtual parties that take part in the protocol (artificially) to augment the security and prevent parties to collaborate and learn private information about other parties' inputs. In the next sections, we discuss variants which do not require a third computational party.

### Cryptographic Security Approach

### Encryption Techniques

The Cryptographically Secure Algorithms that will be discussed in the following sections are applied in one embodiment of the present invention. A well known encryption technique is known as RSA and is based on an algorithm for public-key cryptography from R. L. Rivest, A. Shamir, and L. Adleman, A method for obtaining digital signatures and public-key cryptosystems, Communications of the ACM 21 (1978), 120-126, herein incorporated by reference. This algorithm involves a public key and a private key. While the public key can be known to everyone and is used for encrypting messages, the messages encrypted with the public key can only be decrypted using the private key.

The public key consists of two integers (n; e) and the private key consists of two integers (n; d). To communicate a message, which has been agreed-upon to be an integer m with 1≦m≦n, sender uses the public key to compute the cipher c=m^{e} mod n and transmits it to receiver. To decipher the message, receiver uses its private key to compute c^{d} mod n, which gives exactly m.

Oblivious Transfer (OT) Protocol:

The OT protocol allows a sender to transfer one of potentially many bits to a receiver; however, the sender remains oblivious as to what bit the receiver wants and the receiver remains oblivious about any other bits than the one he has requested. Formally,

OT₁^{k}((b₁, . . . , bₖ),i)=(λ,bᵢ),

where λ denotes the no information symbol.

There is a general approach developed by Goldreich, Micali and Wigderson in GMW to compute Boolean functionalities using circuits composed of XOR and AND gates. The idea is to decompose the desired functionality into a circuit using only these two gates, such that each gate is securely computed.

More precisely, at the beginning of the protocol, the parties exchange shares of each of their inputs. They then compute privately the shares for each gates encountered in the circuit, so that both parties obtain shares of the circuit output. The oblivious transfer (OT) protocol discussed above is used to securely compute shares for the AND gates. Finally they can exchange their shares to compute each the desired functionality. The key point being that the parties only share uniformly drawn bits with the other parties, which implies that at the end of the protocol they obtain the desired functionality, but essentially no other information about the inputs. For a precise description, refer to O. Goldreich, Secure multi-party computation at http://www.wisdom.weizmann.ac.il/home/oded/public html/foc.html (1998) (hereinafter “Gol98”) and herein incorporated by reference.

### Cryptographically Secured Algorithms

The following protocols are effective when used with parties that are honest (following the protocol) but curious (possibly trying to learn more on other parties data sets from their view of their protocol). Extensions to malicious or active adversaries can be addressed using additional approaches such as those found in M. Hirt and J. B. Nielsen, Robust multiparty computation with linear communication complexity, In Crypto 2006, pp. 463-482 (hereinafter “HN”) and herein incorporated by reference.

### Cryptographic Sum-Protocols

A cryptographic protocol is applied for the computing the sum, similar to the Example above. A first approach involves a Boolean based circuit, as in GMW. Another approach for the summation is to use homomorphic thresholding (such as those found in R. Cramer, I. Damgaard, and J. B. Nielsen, Multi-party computations from threshold homomorphic encryption, Proceedings of 20th Annual IACR EUROCRYPT (Innsbruck, Austria), vol. 2045, Springer Verlag LNCS, 2001, pp. 280-300 (hereinafter “CDN01”) and herein incorporated by reference, and M. Franklin and S. Haber, Joint encryption and message efficient secure computation, Journal of Cryptology 9 (1996), no. 4, 217-232 (hereinafter “FH96”) and herein incorporated by reference) and homomorphic encryption schemes. In this arrangement, the homomorphic encryption scheme of Paillier and Benaloh is used to compute securely the sum as follows: (i) each party encrypts its number with an homomorphic public key for addition and sends it to either a trusted party or a party which does not possess the private key; (ii) the receiving party computes the encrypted output (by taking the corresponding function on the encrypted number, this may be a multiplication) and sends back the encrypted output to a party having the private key; and (iii) that party, thus publishes the output.

### Cryptographic Inner-Product-Protocols

We next discuss three algorithms that utilize concepts of Cryptographic Security for calculating the inner product of two vectors.

Arithmetic OT Approach for Secure Inner Product:

We first describe an algorithm to calculate the inner product of two vectors using Oblivious Transfer (OT) algorithm as the building block

### Algorithm 3.

Common inputs: q (the quantization level), t (the time series dimensions).
Party 1 inputs: x₁, . . . , xₜε [symbol] _{q},
Party 2 inputs: y₁, . . . , yₜε [symbol] _{q}.
   1. For i=1, . . . , t,
      (a) party 1 picks xᵢ(2) uniformly at random in [symbol] _{tq}_{²} and reveals it to party 2, who picks yᵢ(1) uniformly at random in [symbol] _{tq}_{²} and reveals it to party 1.
      (b) party 1 picks aᵢ(1) uniformly at random in [symbol] _{tq}2 and sends {−aᵢ(1), −aᵢ(1)+xᵢ(1), −aᵢ(1)+2xᵢ(1), −aᵢ(1)+3xᵢ(1), . . . . , −aᵢ(1)+(tq²−1)xᵢ(1)}(all operations mod qt²) with OT₁^{tq}^{²} to party 2 who picks the yᵢ(2)-th element.
      (c) party 2 picks bᵢ(2) uniformly at random in [symbol] _{tq}_{²} and sends {−bᵢ(2), −bᵢ(2)+xᵢ(2), −bᵢ(2)+2xᵢ(2), −bᵢ(2)+3xᵢ(2), . . . . , −bᵢ(2)+(tq²−1)xᵢ(2)}(all operations mod qt²) with OT₁^{tq}^{²} to party 1 who picks the yᵢ(1)-th element.
      (d) party 1 computes pᵢ(1)=xᵢ(1)yᵢ(1)+aᵢ(1)+bᵢ(1) mod qt² and party computes pᵢ(2)=xᵢ(2)yᵢ(2)+aᵢ(2)+bᵢ(2) mod qt². Now that that these are shares of the product xᵢyᵢ
   2. Party 1 computes p(1)=Σᵢ₌₁^{t}pᵢ(1) mod qt² and reveals it to party 2, w who computes ρ(1)=ᵢ₌₁^{t}pᵢ(1) mod qt² and reveals it to party 1.
   3. Each party computes ρ(1)+ρ(2) mod qt², obtaining the correlation.

This protocol requires O(tq²) OT protocols. This means a possibly high number of public and private encryptions/decryptions (e.g., with RSA). To improve the OT protocols running time, one can use the techniques of M. Naor and B. Pinkas, Efficient oblivious transfer protocols, Proceedings of the SIAM Symposium on Discrete Algorithms (SODA) (Washington D.C.), 2001 (hereinafter “NP01”) and herein incorporated by reference.

Homomorphic Approach for Calculating Inner Product of Two Vectors:

In one arrangement, the data processing system implements homomorphic encryption schemes capable of performing both additions and one multiplication at the same time, such as in D. Boneh, E.-J. Goh, and K. Nissim, Evaluating 2-dnf formulas on cipher texts, In Theory of Cryptography TCC 2005, pp. 325-341 (hereinafter “BGN”) and herein incorporated by reference, to compute the inner-product of two time series. In the following, we assume the use of a public and private key from BGN preventing an overow of tq², where q is the quantization level and t the time series dimensions.

### Algorithm 4.

Common inputs: q, tε [symbol] ₊.
Party 1 inputs: x₁, . . . , xₜε [symbol] _{q}, private and public key.
Party 2 inputs: y₁, . . . , yₜε [symbol] _{q}, public key.
   1. Party 1 encrypts with the public key all of its inputs and sends them to party 2.
   2. Party 2 encrypts with the public key all of its inputs and computes the encrypted multiplication of each parties encrypted inputs for i=1, . . . , t and computes the encrypted sum of these. This provides a public encryption of the inner-product, which Party 2 reveals to Party 1,
   3. Party 1 decrypts with the private key the inner-product and reveals the value to party 1.

The approach of C. Gentry, Fully homomorphic encryption using ideal lattices, Michael Mitzenmacher, editor, STOC, ACM, 2009, pp. 169-178 (hereinafter “Gen09”) and herein incorporated by reference, for fully homomorphic encryption and related efficiency improvements can also be considered for inner-product computations.

Circuit Based Approach for Calculating Inner Product:

We now discuss select protocols using Boolean circuit computations GMW, and A. C. Yao, Protocols for secure computations, 23rd Annual Symposium on Foundations of Computer Science (FOCS), 1982, pp. 160-164 (hereinafter “Yao82”) and herein incorporated by reference.

### Algorithm 5.

Common inputs: k₁, k₂, tε [symbol] ₊.
Party 1 inputs: x₁, . . . , xₜε [symbol] with xᵢ→aᵢ=c₁(i) . . . cₖ_{₁}(i),d₁(i) . . . dₖ_{₂}(i)ε{0, 1}^{k} (this is the binary representation of the number xᵢ, the right of the dot refers to negative powers of 2).
Inputs party 2: y₁, . . . , yₜε [symbol] with yᵢ→bᵢ=e₁(i) . . . eₖ_{₁}(i),f₁(i) . . . fₖ_{₂}(i)ε{0, 1}^{k}.

1. For i=1, . . . , t: Party 1 draws k bits uniformly at random, denoted by ai[2], reveals them to party 2 and create shares of ai by constructing aᵢ[1]=aᵢ⊕aᵢ[2], which is kept private. Party 2 draws k bits uniformly at random, denoted by bi[1], reveals them to party 1 and create shares of bi by constructing bᵢ[2]=bᵢ⊕bᵢ[1], which is kept private.

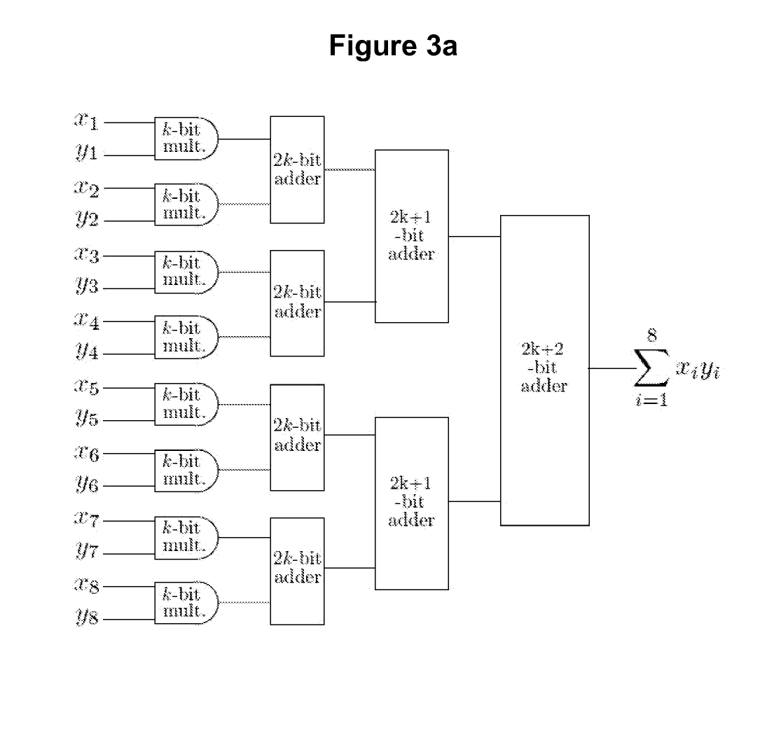

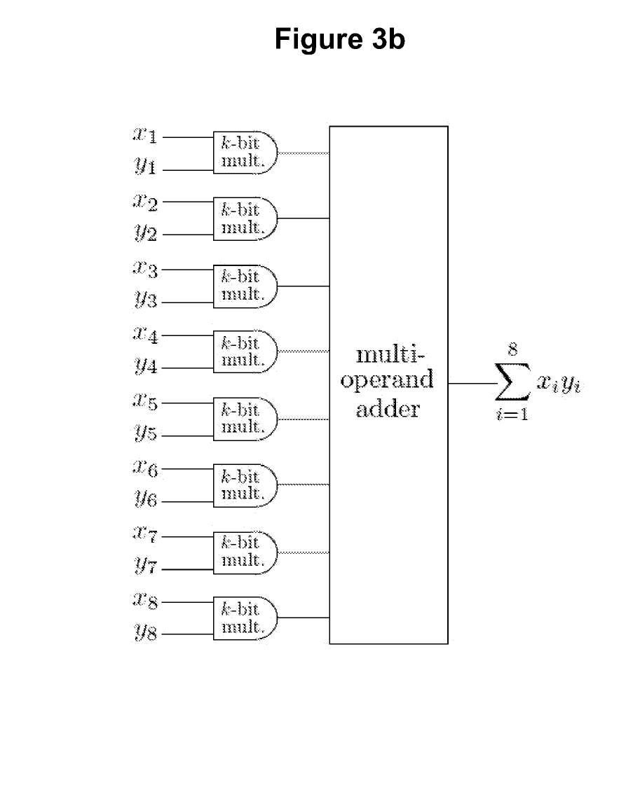

2. Each party computes privately and in parallel the shares of the first n/2 AND gates, namely the circuit of FIG. 3a or 3b is run and for each XOR gate encountered, the parties individually add their shares and for each AND gate encountered, the parties emulate a private computation by computing shares of the AND-gate output with the OT protocol. For the circuit of FIG. 3a, the parties compute privately and in parallel the shares of the 2k-bit adders, then the (2k+1)-bit adders, etc., until the (2k+log₂ t−1)-bit adder.

3. After the computation of the last gate, each party exchange their shares to compute the output of the circuit given by Σᵢ₌₁^{l}xᵢyᵢ.

Illustrative circuits (two circuits are provided) are used to show how the GMW protocol runs explicitly for the inner-product. FIG. 3a is a diagram of a circuit for the real inner product of 8-dimensional vectors with k-bit components using a butterfly-structure for the addition gates. In FIG. 3a, the additions are done according to a tree structure, allowing parallelizing several computations in common rounds. FIG. 3b is a diagram of a circuit for the real inner product of 8-dimensional vectors with k-bit components using a joint multi-operand adder for the additions, which can be implemented using Wallace-tree, prefix free or other optimized adders. In FIG. 3b, we use a more general multi-operand adder that can be computed using prefix-free or Wallace-tree techniques. More generally, one can optimize the circuit (e.g., using Secure Hardware Definition Language) to minimize the number of AND gates or of communication rounds. One can also use the approach of Yao82 to valuate these circuits. This protocol can be implemented with a single OT protocol for each input wire in the circuit. Party 1 constructs the circuit and converts it into a garbled circuit, which it provides to party 2. Then the parties run an OT protocol for each input wire. Once done, party 2 evaluates the circuit independently.

### Cryptographic Quantile-Protocol

A secure protocol for the computation of the quantiles of n real quantized numbers is achieved by having a secure protocol for computing the k-th ranked element in a set of integers and using proper scaling of the real numbers. We also propose a circuit-base approach (GMW, Yao82, and D. Beaver, S. Micali, and P. Rogaway, The round complexity of secure protocols, ACM Sympos. on Theory of Comput. (STOC) (New York, N.Y.) (hereinafter “BMR”) and herein incorporated by reference) to compute such a function, as described generically in previous sections. For that approach, we propose to use a circuit optimizer (e.g., using Secure Hardware Definition Language) for the k-th ranked element function and then run a Yao, BMR or GMW protocol (GMW, Yao82, and BMR) to compute securely that circuit and hence obtain the k-th ranked element, leading to the desired quantized quantile. We also propose the use of the techniques developed in NP01 for amortizing OT protocols to improve the computational time and the use of the BMR protocol to afford a fix number of communication rounds, improving the overall running time of the protocol. An efficient protocol specified for k-th ranked element computation has also been developed in G. Aggarwal, N. Mishra, and B. Pinkas, Secure computation of the kth-ranked element, In Advances in Cryptology, Proc. of Eurocyrpt, 2004 (hereinafter “AMP04”) and herein incorporated by reference, and we refer to this protocol as a possible implementation of the k-th ranked element, which can be then be used in the novel financial application described in this patent.

As noted above, there are a number of useful applications of the present invention. For system wide aggregate quantities such as equity, leverage and concentration index for example, regulators can use the secured sum algorithm to calculate system wide assets, liabilities, equity or leverage for a group of financial institutions. Such calculations can be carried out for specific groups of institutions and/or for a specific class of assets. Exemplary subsets of data include (i) the leverage of all commercial banks with assets less than 100B or (ii) total amount of subprime related assets held by all commercial banks. A simple extension, by using the algorithm first to get total assets and for a second time to get weighted sum, can be used to calculate other metrics of interest such as asset-weighted leverage. Also calculating concentration index such as the Herfindahl index requires application of the sum algorithm twice—first to calculate the total market size and then to calculate sum of the squared market shares. The same algorithm can be used to calculate the true average or asset weighted average of Net Asset Value (NAV) across the entire money-market segment of the financial markets. An NAV that varies from (1) or is too volatile may be used as an indicator of potential systemic risk. Note that in this approach, since no private data is revealed parties have more incentive to cooperate.

For system-wide aggregate risk exposure, the parties have agreed to express their risk on a number of dimensions (for example their P&L to 1% drop in S&P level or to 5% increase in VTX, etc.). One possible way this can be achieved is by using standardized risk software such as those offered by MSCI BARRA or Northfield Information Services. The algorithms discussed, in particular the secured sum and quintile, can be used to aggregate these metrics across the participating firms. In one embodiment, the process through which each firm calculates its exposure to each of the agreed upon risk factor can be based on statistical analysis of their historical performance. Alternatively, the process through which banks calculate their exposure to various risk factors can be reflective of hypothetical future realizations that may have not occurred in the observed historical period, for example a default by a sovereign credit. This is closer to the way that bank stress-test in US or EU was done in the last few years. In both cases, the proposed algorithms can be used to calculate aggregate risk metrics such as total risk exposure or various quintiles of risk exposure across the financial industry.

Another application involves monitoring an exchange and specifically the systemic liquidity risk of the exchange. In this application, exchanges institute a process through which various electronic trading firms (high-frequency trading firms or sell-side execution algorithms) privately calculate the response of their algorithms to a set of defined scenarios. The response may be measured in terms of the liquidity demanded or supplied by these algorithms in a defined market scenario over a defined period of time. The techniques discussed above are used to aggregate these privately calculated metrics to generate real-time measures of potential liquidity risk.

In one hypothetical example firms using electronic execution algorithms (such as VWAP—the Volume Weighed Average Price Algorithm) to buy or sell various securities during a given trading day calculate their total liquidity demand or supply (i.e., how much they are planning to buy or sell using non-price sensitive algorithms) over a specific future period under various set of adverse conditions (such as sudden drop the overall stock market level, rise in volatility, etc). Given their knowledge of their order size and the way their algorithms are programmed to respond to various market events, it should be possible for firms to privately calculate these values. These privately calculated liquidity demand and supply can be aggregated (using the techniques for secured computations provided above) and monitored to provide market vulnerability metrics.

Another monitoring application involves private equity or investment. It is often the case that large institutional investors, such as pension funds or endowments, give some of their money to outside investment managers. The above process and system operate to assist these private institutions to more effectively monitor the risks taken by these out-side managers without the need to know the detail of their investment approach, their strategies of other proprietary information. For example, the outside managers can agree, as condition for getting the mandate, to use their daily P&L calculation and our secure correlation algorithm to calculate correlation between their P&L and other private investments that the pension may have invested in.

In yet another hypothetical application of these techniques, prime broker can use the algorithms discussed to better measure or manage their counter party risk. For example, a prime broker can use the correlation algorithm discussed herein to obtain the degree of similarity between historical performance, holding or risk exposure across multiple funds without needing to obtain private data from each fund.

Additional applications reside in financial audits. Most assets held by commercial banks are not traded in highly liquid markets. Financial auditors are required to value these assets based on estimates and assumptions about future market conditions including possible credit impairment. The tools discussed above will assist auditors to compare their valuation for similar classes of assets with valuation assigned by at other banks. In one arrangement of this application, all participating banks enter their assigned value to a specifically defined class of assets (for example mortgages extended to buyers with certain FICO score, in certain geographical area and with certain LTV) and techniques provided above such as the quintile algorithm, are used to aggregate data such as histogram of the values entered by various participating banks. This allows a higher level of transparency without revealing information about each banks positions, valuations, etc. Firms outside of certain band would then know their assigned valuation is outside of norm used by competitors. This indicates, for example, that should the “optimistic” bank fail, the assets would not likely be purchased by competitors without government support.

Yet another application of the present invention is due diligence as it relates to private investments. This is based on due diligence of historical performance before an institution (say a pension fund) decides to hire a new outside manager (say a hedge fund). The techniques discussed are used to calculate historical correlation or other metrics of interest such as conditional distribution, between that new funds historical performance and, for example, the historical performance of other hedge funds that the pension fund has already invested in. The foregoing secured computation techniques also can be applied, for example, to assist a hedge fund seeking a new portfolio manager (PM) and the due diligence on the new PM, including the calculation for the correlation between the new PMs performance and their own historical performance. Neither party needs to share with the other party the actual historical data but, instead, each party can rely on the results in assessing the opportunity.

Yet another application involves the creation of new trading indices based on application of the above system design. Currently most indexes that are used as the underlying for traded financial contracts (such as the Dow Jones Index or credit indexes) are based on value of financial assets that are traded in a market. As discussed above, many assets of commercial banks are not traded in such fashion. The inventive approach provided herein allows a number of participants to calculate an index based on their internally assigned values to such assets. The calculated index can then be used for defining new financial contracts. In this case, the participating entities, again commercial banks, use the secure sum algorithm (or simple extensions such as secured weighted sum) to calculate the current average (or weighted average) for the value they have internally assigned to their assets. The value of the index can then be published. This new index can credit or transfer risk in the financial system even among assets that are not very often traded.

A further application of the present invention involves information collected from social network systems such as Facebook™ or similar. There are instances where aggregate data across a pool of network participants is desired but would be precluded due to privacy and related concerns. The present invention allows for the aggregation of individual data regarding participants in a social network while preserving the security and privacy of data on an individual basis. Use of the current system design allows for statistical analysis of key demographic and other private data in a seamless and efficient manner unrealized by other techniques.

There are other possible applications outside of finance, based on similar information constraints. For health care, the inventive system permits tracking of a various aggregate performance parameters of, for example, hospitals, clinics and other medical outlets, while protecting the information associated with the individual participants in the group. Aggregate information of this nature would be needed by the Center for Disease Control (CDC) or other entities entrusted with protecting public health, in various insurance companies or industry consortiums. Other similar applications are found in real estate, where, for example, individual property owners or lien holders have private information that collectively supports highly valuable aggregate measures for specific market attributes.

The invention described above is operational with general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

Components of the inventive computer system may include, but are not limited to, a processing unit, a system memory, and a system bus that couples various system components including the system memory to the processing unit. The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system typically includes a variety of non-transitory computer-readable media. Computer-readable media can be any available media that can be accessed by the computer and includes both volatile and nonvolatile media, and removable and non-removable media. By way of example, and not limitation, computer-readable media may comprise computer storage media and communication media. Computer storage media may store information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The computer system may operate in a networked environment using logical connections to one or more remote computers. The remote computer may be a personal computer, a server, a router, a network PC, a peer device or other common network node, and typically includes many or all of the elements described above relative to the computer. The logical connections depicted in include one or more local area networks (LAN) and one or more wide area networks (WAN), but may also include other networks. Such networking environments are commonplace in offices, enterprise-wide computer networks, intranets and the Internet.

For ease of exposition, not every step or element of the present invention is described herein as part of software or computer system, but those skilled in the art will recognize that each step or element may have a corresponding computer system or software component. Such computer systems and/or software components are therefore enabled by describing their corresponding steps or elements (that is, their functionality), and are within the scope of the present invention. In addition, various steps and/or elements of the present invention may be stored in a non-transitory storage medium, and selectively executed by a processor.

The foregoing components of the present invention described as making up the various elements of the invention are intended to be illustrative and not restrictive. Many suitable components that would perform the same or similar functions as the components described are intended to be embraced within the scope of the invention. Such other components can include, for example, components developed after the development of the present invention.

What is claimed is:

1. A computer system comprising:
at least one processing unit;
memory operatively connected to the at least one processing unit, wherein the memory comprises executable instructions that when executed by the at least one processing unit cause the at least one processing unit to carry out a method comprising:
obtaining confidential financial data;
transmitting a first set of one or more random numbers to each of one or more participating institutions;
receiving a second set of one or more different random numbers from each of the one or more participating institutions;
generating a public number based on the confidential financial data and the second set of one or more different random numbers received from each of the one or more participating institutions; and
outputting the public number.

2. The computer system of claim 1, wherein outputting the public number comprises transmitting the public number to at least one of:
an auditing institution;
a regulating institution;
an exchange;
the other participating institutions;
one or more clients; and
one or more brokers.

3. The computer system of claim 1, wherein outputting the public number comprises publishing the public number in a publicly available medium.

4. The computer system of claim 1, wherein generating the public number comprises applying an information theoretic algorithm.

5. The computer system of claim 4, wherein the information theoretic algorithm comprises a secure sum algorithm.

6. The computer system of claim 1, wherein the method further comprises the step of detecting fraud.

7. The computer system of claim 1, wherein the method further comprises the steps of:
transmitting a third set of one or more random numbers to each of one or more virtual parties, wherein the one or more virtual parties comprise artificial participating institutions;
receiving a fourth set of one or more different random numbers from each of the one or more virtual parties; and
generating the public number based on the confidential financial data, the third set of one or more different random numbers received from each of the one or more virtual parties, and the fourth set of one or more different random numbers received from each of the one or more participating institutions.

8. The computer system of claim 1, wherein the confidential financial data comprises at least one of:
total equity;
average leverage ratio;
aggregate value at risk; and
Herfindahl index.

9. A non-transitory computer readable medium comprising executable instructions that when executed by one or more processing units cause the one or more processing units to carry out a method comprising the steps of:
obtaining confidential financial data;
transmitting a first set of one or more random numbers to each of one or more participating institutions;
receiving a second set of one or more different random numbers from each of the one or more participating institutions;
generating a public number based on the confidential financial data and the first set of one or more different random numbers received from each of the one or more participating institutions; and
outputting the public number.

10. The computer system of claim 9, wherein outputting the public number comprises transmitting the public number to at least one of:
an auditing institution;
a regulating institution;
an exchange;
the other participating institutions;
one or more clients; and
one or more brokers.

11. The computer system of claim 9, wherein outputting the public number comprises publishing the public number in a publicly available medium.

12. The computer readable medium of claim 9, wherein generating the public number comprises applying an information theoretic algorithm.

13. The computer readable medium of claim 12, wherein the information theoretic algorithm is a secure sum algorithm.

14. The computer readable medium of claim 9, wherein the method further comprises the step of detecting fraud.

15. The computer readable medium of claim 9, wherein the method further comprises the steps of:
transmitting a fourth set of one or more random numbers to each of one or more virtual parties;
receiving a fourth set of one or more different random numbers from each of the one or more virtual parties; and
generating the public number using the secret data, the third set of one or more different random numbers received from each of the one or more virtual parties, and the fourth set of one or more different random numbers received from each of the one or more participating institutions.

16. The computer readable medium of claim 9, wherein the secret financial data comprises at least one of:
total equity;
average leverage ratio;
aggregate value at risk; and
Herfindahl index.

17. A non-transitory computer readable medium comprising executable instructions that when executed by one or more processing units cause the one or more processing units to carry out a method comprising the steps of:
receiving a plurality of public numbers from a plurality of participating institutions;
wherein the plurality of public numbers were generated based on confidential financial data from each of the participating institutions and on a set of one or more different random numbers received by each of the plurality of participating institutions from every other participating institution of the plurality;
aggregating the plurality of public numbers; and
generating a metric based on the aggregated plurality of public numbers.

18. The computer readable medium of claim 17, wherein the metric is generated iteratively to provide at least one of:
financial correlation data;
financial covariance data; and
financial quantile data.

19. The computer readable medium of claim 17, wherein the metric comprises at least one of:
total equity;
average leverage ratio;
aggregate value at risk; and
Herfindahl index.

20. The computer readable medium of claim 17, wherein generating the plurality of public numbers comprises applying an information theoretic algorithm.
